(19) United States
(12) Patent Application Publication
(10) Pub. No.: US 2006/0256288 A1
(43) Pub. Date: Nov. 16, 2006

(54) Projector system

(75) Inventor: Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/554,617

(22) PCT Filed: Apr. 28, 2004
(86) PCT No.: PCT/IB04/50536

§ 371 Date: Oct. 27, 2005

(30) Foreign Application Priority Data
May 1, 2003 (EP) 03101206.5

(51) Int. Cl. G03B 21/14

(52) U.S. Cl. 353/20

(57) ABSTRACT

A projector system comprises an illumination-optical system (1), a colorseparating system (4) which separates light coming from the illumination-optical system (1) into at least three beams of colored light (R,G,B), the system further comprising, for each beam of colored light, a modulation device (16, 18, 19) for modulating the beam of colored light, and a color combiner (20) which combines the modulated color beams. The projector system comprises a polarization conversion system (PCS) for at least one colored beam and no polarization conversion system for at least one of the other colored beams.

### FIELD OF THE INVENTION

The invention relates to a projector system comprising an illumination-optical system, a polarization conversion system, a color-separating system which separates light coming from the illumination-optical system into at least three beams of colored light, the system further comprising, for each beam of colored light, a modulation device for modulating the beam of colored light, and a color combiner which combines the modulated color beams.

### BACKGROUND OF THE INVENTION

Such a device is known from European patent application no 1 071 292.

A projector usually comprises an illumination-optical system, a color-separating system and modulation devices, such as liquid crystal panels for modulating the colored light beams. The colored modulated light beams are then combined and projected onto a screen by a projection lens or lens system. If the modulators add image information to the light beam by means of polarization modulation, the modulator, such as a liquid crystalline display panel, is generally situated between two polarizers. If unpolarized light is incident on the display panel, substantially half of it will be absorbed by the first polarizer and thus will be lost by the formation of the image. This absorption also gives rise to heating of the polarizer and the display panel. To alleviate this problem, the known device comprises a polarization conversion system (PCS). A polarization conversion system converts the light emitted by the light source, which is not polarized into a polarized light beam preferably with a minimum loss of light. In order to do so, conventional polarization conversion systems have two arrays of lenses and a polarized light-generating system, the polarization conversion system comprising a shading plate, a polarizing beam splitter array and a selective retardation plate. The lens arrays are arranged in such a way that the light from the light source is split into a number of beams and that said beams enter only at the transparent parts of the shading plate. The polarizing beam splitter separates the entering beams into s-polarized beams and p-polarized beams. One type of these beams is sent to a polarization-altering element, such as a selective retardation plate wherein the polarization is changed from s to p or from p to s. The end result is that the light exiting the polarization conversion system is polarized in one direction, the s or p direction. This light is then sent to the color-separating system, modulated by the respective color modulation devices, recombined in the color combiner and projected on a screen.

Although the known system works satisfactorily and offers advantages, a number of problems remain. The polarization conversion system is a very expensive system, and it is difficult to obtain and maintain a high quality for this system.

### OBJECT AND SUMMARY OF THE INVENTION

It is an object of the invention to alleviate or at least reduce one or more of the above-mentioned problems.

To this end, the projection system according to the invention is characterized in that the projector system comprises a polarization conversion system for at least one colored beam and no polarization conversion system for at least one of the other colored beams.

The projection system according to the invention thus has a polarization conversion system for one of the colors, i.e. at a position at which the colors are separated. The other color beams are thus not polarized before they enter the modulation devices.

Prima facie, one might think that this is a step backwards from the known system.

However, the inventors have realized the following.

Systems based on light modulation use projection lamps that emit unbalanced red, green and blue colors. High brightness, costs and a proper color reproduction are the most important aspects of these systems. For proper color reproduction, which is of special importance for projecting photo and video images, up to 40% of two of the colors (usually green and blue) is actually thrown away and cannot be used at high intensity, because it would not give a proper color rendition, especially not a proper white color balance. The PCS in known projector systems has to work for all colors, which requires a costly system and, in reality, some compromise will have to be made wherein a less than perfect polarization conversion is obtained for all colors so as to get an optimum for all colors combined. Even with a PCS, some percentage of the light will thus be lost in known systems, because the PCS is less than perfect and the PCS itself (due to e.g. reflections on surfaces) may be a cause of loss of intensity. All in all, not using the PCS for two colors does not seriously affect the loss of light for these colors. In fact, removing the PCS from these light paths reduces the number of elements in these light paths, which reduces the complexity of the optical system and may even lead to an improvement for these colors. A PCS is positioned in the light path of the third color, usually red, i.e. after the light beams have been separated. This PCS deals with one color only, i.e. with a much smaller wavelength range than the PCS in the known system. Almost all constituent elements (splitters, retardation plates, etc.) of the PCS have optical properties that are wavelength-dependent, which makes it difficult and costly to provide a PCS system operation for all colors. However, in the system according to the invention, the PCS system deals with one color only, and this allows a reduction in costs and yet an improvement in performance. For instance, anti-reflective layers which reduce reflection on surfaces for all visible wavelengths are usually much more complex than for red only.

The overall system thus does not suffer from a significant loss of quality for the two colors paths in which there is no PCS in the projector system according to the invention, and there is some increase of quality for the color path in which there is a PCS in the system in the invention, while a significant cost reduction is obtainable.

The invention thus offers the possibility of a cost reduction without an appreciable reduction of image quality and without requiring a major change of design (although some design changes are needed).

The projection system preferably comprises, for at least one of the color beams, a relay system between the color-separating system and the color combiner, and a polarization conversion system is positioned in the relay system.

The PCS is preferably positioned in the relay system. In the relay system, the beam path is lengthened to provide room for positioning a PCS without the need to considerably change the general layout of the projector system or of the color-separating system in particular.

It is noted that it is known per se to provide a relay system in or for the color-separating system. “Between the color-separating system and the color combiner” is meant to indicate the positioning of the relay system seen along the beam path.

In a preferred embodiment, the PCS is positioned in the red beam path, and, in operation, the relay system preferably relays a red beam.

Most lamps have an unbalance in the light emission, such that blue and green light have to be reduced for a proper white balance. In such circumstances, it is advantageous to provide the PCS in the red beam path. Within the broader concept of the invention, the PCS may be provided for colors other than red, provided that the color for which the PCS is provided is a color that is relatively lacking for a proper white balance from the light emitted by the illumination system. To put it differently, in such circumstances, the other colors are relatively too bright for a proper white balance.

### BRIEF DESCRIPTION OF THE DRAWINGS

In the drawings:

FIG. 1 is a sectional view of a known projector system.

FIGS. 2, 3(A) and 3(B) illustrate schematically one example of a PCS.

FIG. 4 illustrates a projector system according to the invention.

FIGS. 5 and 6 illustrate details of the system shown in FIG. 4.

The cooperation of various parts of the system shown is detailed in FIG. 7.

The Figures are not drawn to scale. Generally, identical components are denoted by the same reference numerals in the Figures.

### DESCRIPTION OF EMBODIMENTS

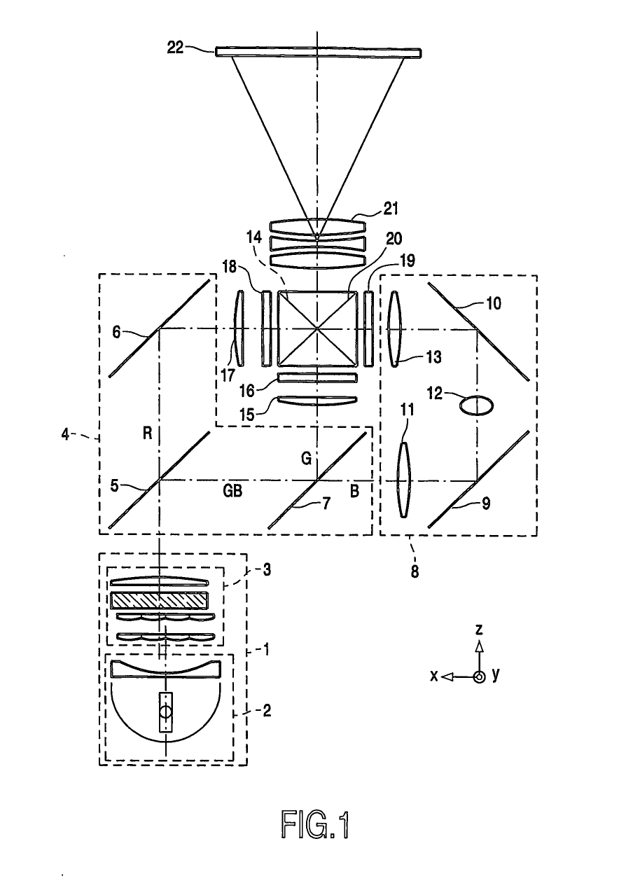

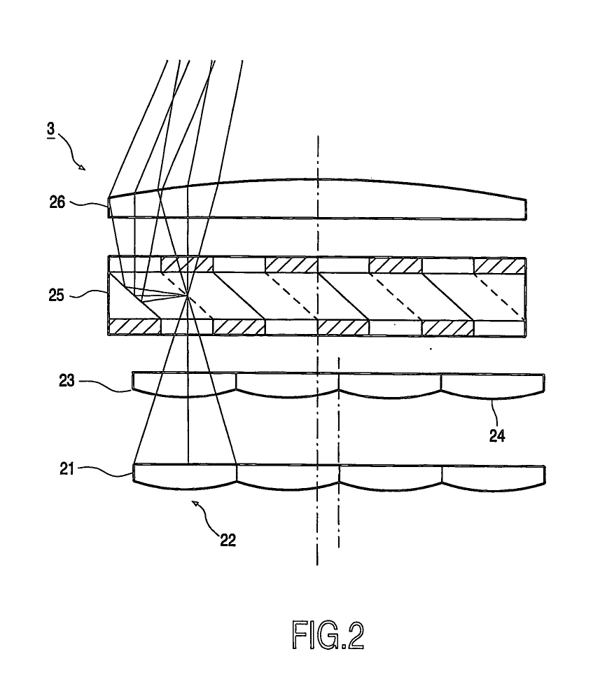

FIG. 1 shows a projector system as known from the prior art. The projector system comprises an illumination-optical system 1, comprising a lamp and a parabolic projector 2. The light emitted by the lamp passes a polarization conversion system (PCS) 3. This system converts the unpolarized light emitted by the lamp into polarized light. One way of doing this is explained in FIG. 2. The light is split into three colored light beams in a color-separating system 4 comprising a number of (semi-transparent) mirrors 5, 7 and a folding mirror 6. In one of the light paths in the known system, the blue light is relayed via a relay system 8 having a number of mirrors 9, 10 and a number of relay lenses 11, 12, 13. Via lenses 13, 15 and 17, the three light beams are incident on modulators 16, 18 and 19 by which the colored light beams are modulated. The light beams are recombined in color combiner 14 and projected on a screen 22 via projector lens system 21.

FIG. 2 illustrates PCS 3 as described for the known projector system in EP 1 071 292. In general, in a polarization conversion system, the original light beam having different directions of polarization is separated by a polarization-sensitive beam splitter into two sub-beams having different directions of polarization that are perpendicular to each other. In a polarization conversion means, the direction of polarization of one of these beams is converted into the polarization direction of the other one of said beams, and the converted sub-beam is subsequently combined with the unconverted sub-beam to provide, in combination, a polarized light beam.

FIGS. 2,3(A) and 3(B) illustrate schematically one example of a PCS. Two arrays 21, 23 of lenses 22, 24 are arranged in front of the actual PCS 25. These lenses split the incoming, nearly parallel light beam coming from the lamp and reflector into a number of partial light beams. The partial light beams enter the PCS 25, which comprises a shading plate 31 having light-blocking areas 32 (which could be reflective) and transmissive areas 33. The light is concentrated and passes the transmissive areas 33 entering a polarization-sensitive beam splitter 34 with transmissive members each having a roughly parallelogram shape. Each member has a surface 35 that passes light having one polarization direction (in this example, the p-polarization) while reflecting light with the other polarization (in this example, s-polarisation), and the reflected light is again reflected on surface 36. The s and p-polarized light beams enter a polarization conversion means 37 having areas 38 and 39 in which one of these areas changes the polarization direction of the light by 90 degrees. In this example, the p-polarized light beams are converted into s-polarized light beams. The net result is that the incoming unpolarized (s+p) light is converted in PCS 25 into polarized (in this example, s-polarized) light. Quarter-wave films may be used for such a conversion.

The modulators 16, 18 and 19 usually comprise polarizers or operate only on polarized light. Light with the “wrong” polarization is absorbed before or in the modulators and is thus lost, leading only to an increase of heat in the projector system. The provision of the PCS system therefore offers advantages.

However, systems based on light modulation use projection lamps that emit unbalanced red, green and blue colors. High brightness, costs and a proper color reproduction are the most important aspects of these systems. For proper color reproduction, up to 40% of two of the colors (usually green and blue) is actually thrown away and cannot be used at or near full intensity, because it would not give a proper color rendition, especially not a proper white color balance. This leads to a considerable heat input. To put it simply, there is far too much intensity in two of the color beams, and not enough in the third, and the surplus in the first two is thrown away to obtain proper white colors. Any white unbalance will lead to this situation, although the amount of unbalance and the actual colors that are too bright or too weak, and the extent of brightness or weakness of these colors may differ in dependence on the lamp used. In most systems, the surplus of blue and green is some 40%, as described. This surplus is comparable to what is gained by using the PCS system for these colors. The PCS system itself is a costly system and complicated, in particular because it has to function over all wavelengths. The inventors have realized that the cost can be reduced by putting a PCS only in one of the color light paths, i.e. after splitting the light beams into color light beams. Putting the PCS in the “weakest” light beam enables the PCS to be made simpler because only a limited wavelength range is of importance, thus saving costs, while yet functioning better. Many or all of the elements used in the PCS are polarization-dependent but usually also wavelength-dependent. A quarter-wave plate that needs to work for only one color is much easier to construct than a quarter-wave plate that needs to operate for the full white light range. A quarter-wave plate that needs to work for one color can be made from a single, uniaxial film, while a wideband quarter-wave plate that needs to work in the full visible center is made of a stack of 3 (or even more) uniaxial films. Similar anti-reflex coatings for a wide spectral range require a stack with a larger number of layers than anti-reflex coatings that need to have low reflections at only a single color. Restricting the PCS to one color only removes many of these problems and therefore offers the possibility for a better PCS to be made for less money. For the two other colors, the optical system is simplified, which also offers advantages because the more elements an optical system contains, the more losses may generally occur and the more stringent requirements will be imposed, such as for alignment of optical elements. It is true that 50% of the light in these two light channels will have to be dumped, but in the existing system a small percentage is always lost because of the presence and inherent imperfection of the PCS and, in practice, some 40% is lost due to the unbalance in the light emitted by the lamp. The net result for these two colors is thus small. The net result for the color in which the PCS is positioned is positive because a PCS can be made which is better tuned to the color of the light

Most lamps have an unbalance in the light emission, such that blue and green light have to be reduced for a proper white balance. In such circumstances, it is advantageous to provide the PCS in the red beam path. Within the broader concept of the invention, the PCS may be provided for colors other than red, provided that the color for which the PCS is provided is a color that is relatively lacking for a proper white balance from the light emitted by the illumination system. To put it differently, in such circumstances, the other colors are relatively too bright for a proper white balance. It is remarked that, in most current systems, light is separated into three colored beams, which are modulated and then recombined. In systems where the light would be separated into more than three colors (e.g. four), the invention is also applicable.

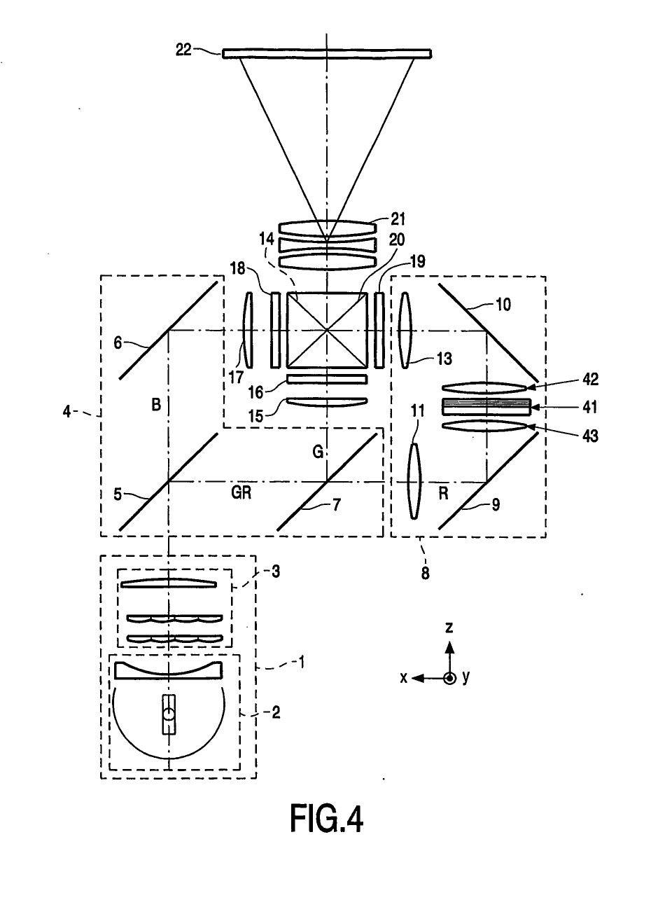

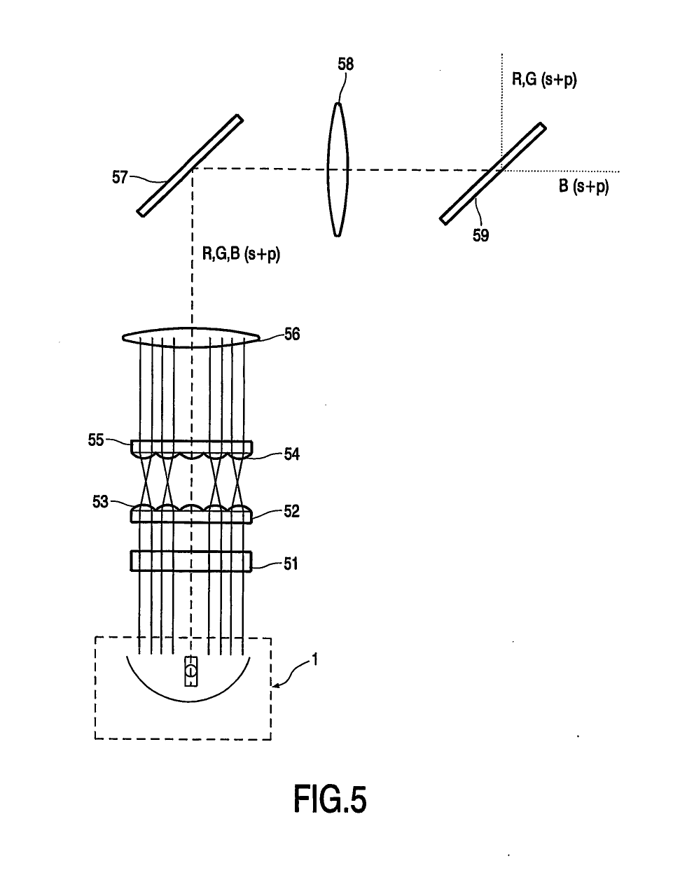

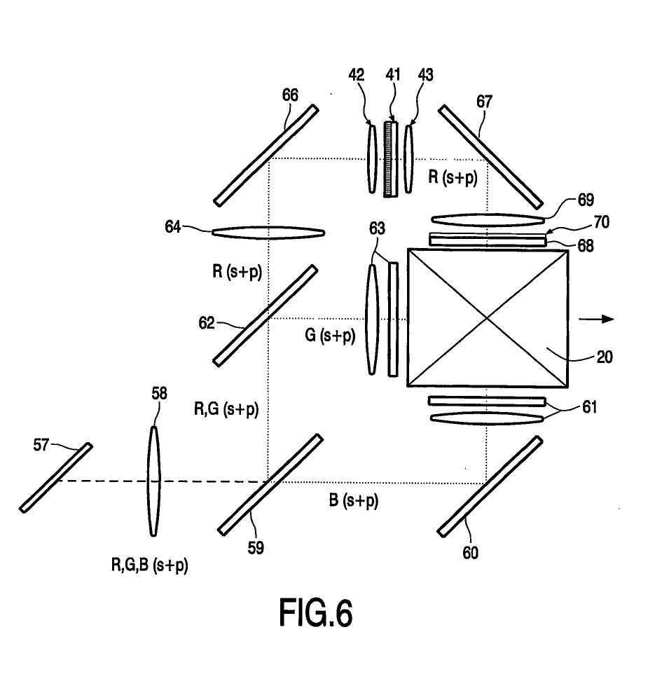

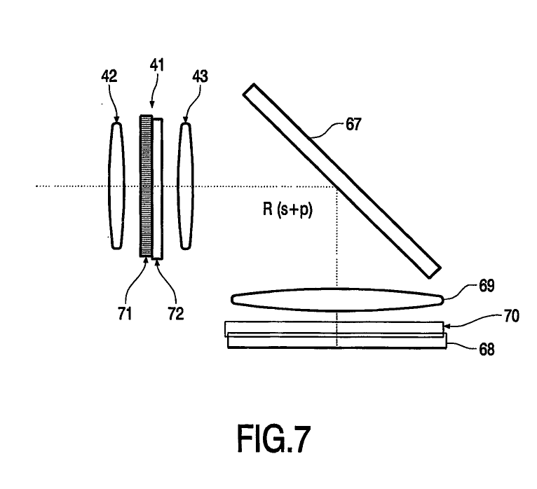

FIG. 4 illustrates a projector system according to the invention. FIGS. 5 and 6 illustrate details of the system shown in FIG. 4.

Compared to the known system, the PCS is removed from the part of the projector system before the color separation system, and the red beam is relayed, and a PCS 41 is provided between lenses 42 and 43 in the relay system. FIG. 4 shows the system schematically.

FIGS. 5 and 6 illustrate some details of the system schematically shown in FIG. 4.

FIG. 5 illustrates the light illumination system. It comprises a lamp and reflector 1, a UV filter 51, and two integrators 52 and 54, each comprising a number of lenses 53, 55, positioned in such a way that the parallel beam entering the first integrator is split into a number of parallel beams exiting the second integrator. For the side beams, this is schematically indicated in the Figure. The light is reflected by a mirror 57, which in this embodiment doubles in function as a IR filter, relayed by lens 58 to a first dichroic color filter 59 (comparable to color filter 5 in FIG. 4). It is remarked that FIG. 4 shows the design schematically and in a condensed form with some details not being shown in FIG. 4 so as to make it possible to see the general design of the device. In particular, for simplicity, the mirror 57, and relay lens 58 (as well as the angle in the light path due to the provision of the mirror 57) are not shown in FIG. 4 but in FIG. 5. The actual light path between the light illumination system and the color separation system does not limit the scope of the invention. The blue beam is transmitted by mirror 59, while the red and green light are reflected upwards. All light at this stage is unpolarized, i.e. it comprises s and p polarization.

FIG. 6 illustrates the next part of the projector system. The elements 57, 58 and 59 are the same as in FIG. 5. The R and G beams are split by dichroic mirror 62. The Blue (B) and Green (G) are modulated by modulation devices 61 and 63. Field lenses are arranged in front of the modulation devices (usually LCD devices). As already discussed, given the fact that the light incident on the B and G modulation devices 61, 63 is unpolarized and the modulation devices conventionally comprise polarizers, 50% of the G and B light will not pass the modulators, but will be lost. However, as already explained, due to the color unbalance of the illumination device, some 40% of the light would have to be stopped (in the modulation devices) anyway.

The red beam is relayed via lens 64 and mirrors 66 and 67 to modulation devices 68 via field lens 69. In the relay system, a PCS 41 is arranged between lenses 42 and 43. The image of the integrators 52, 54 is formed between lenses 42 and 43, thus forming a pattern of bright spots, which in fact form the image of the bright spots at integrator 54, which spots are schematically indicated in FIG. 5 by the points where the lines indicating the light beams cross one another. There are dark spaces between these bright spots. In this example, a reflective polarizer 70 is positioned in front of the modulation device.

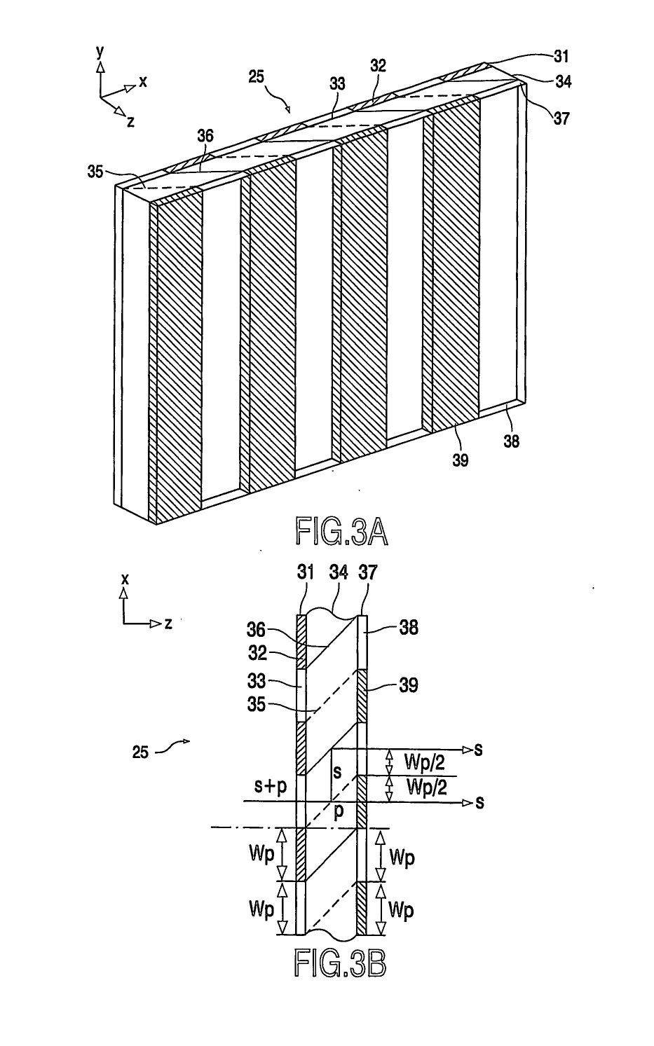

The cooperation of the various parts in the last part of the system is shown in detail in FIG. 7. Arranging a mirror pattern 71 between lenses 42 and 43 at or near the location of these bright spots allows the light to pass the mirror pattern, while the light that has passed the mirror pattern will be incident on reflective polarizer 70 in front of modulation device 68. The “right” polarization will pass and be modulated, whereas the “wrong” polarization will be reflected. The various lenses and other optical elements are aligned in such a way that the reflected polarization mode generates a second image of the integrator plate at substantially (preferably exactly) the same plane between the lenses 42 and 43, i.e. a pattern of bright spots with dark spaces in between, but slightly shifted in a direction in the plane, such that the light is re-reflected by the mirror pattern. The mirror pattern is provided with a quarter-wave film, to rotate the polarization of the bounced light This light will pass the reflective polarizer. Thus, a PCS system is provided in the relay system. This PCS comprises the mirror pattern 71 which is positioned in such a way that the bright spots coincide with the holes in the mirror pattern and thus pass through the quarter-wave film 72 at the back of the mirror pattern and the reflective polarizer 70 in front of the modulator. Such an arrangement with a patterned mirror plate, provided with a quarter-wave film and a reflective polarizer is a preferred embodiment, as the arrangement of a patterned mirror plate and a quarter-wave film is much simpler and thus less costly, as can be seen when compared to the PCS of FIGS. 3A and 3B. The provision of the reflective polarizer does not add substantial costs.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A projector system comprising an illumination-optical system (1), a color-separating system (4) which separates light coming from the illumination-optical system (1) into at least three beams of colored light (R,G,B), the system further comprising, for each beam of colored light, a modulation device (16, 18, 19) for modulating the beam of colored light, and a color combiner (20) which combines the modulated color beams, characterized in that the projector system comprises a polarization conversion system (PCS) for at least one colored beam and no polarization conversion system for at least one of the other colored beams.

2. A projector system as claimed in claim 1, characterized in that that the projector system comprises, for at least one of the color beams (R), a relay system (8) between the color-separating system (4) and the color combiner (20), and in that a polarization conversion system (PCS) is positioned in the relay system.

3. A projector system as claimed in claim 1, characterized in that the PCS is positioned in the red beam path (R).

4. A projector system as claimed in claim 1, characterized in that the PCS comprises a patterned mirror plate (71) provided with a quarter-wave film (72) and a reflective polarizer (70).

5. A projector system as claimed in claim 1, characterized in that no PCS is provided for any of the other colors.
